(19) United States
(12) Patent Application Publication
(10) Pub. No.: US 2006/0235168 A1
(43) Pub. Date: Oct. 19, 2006

(54) Resin composition and method for manufacturing the same

(76) Inventor: Takayoshi Kuwabara, Shizuoka (JP)

Correspondence Address: YOUNG & THOMPSON, 745 SOUTH 23RD STREET, 2ND FLOOR, ARLINGTON, VA, 22202, US

(21) Appl. No.: 11/386,810

(22) Filed: Mar. 23, 2006

(30) Foreign Application Priority Data
Mar. 30, 2005 (JP) 2005-099178

(51) Int. Cl. C08L 77/00

(52) U.S. Cl. 525/432

(57) ABSTRACT

A method for manufacturing a resin composition which comprising a thermoplastic resin and inorganic particles having major axes less than 1 μm and aspect ratios in a range of from 3 to 1000 and dispersant both of which are frozen and dried at a temperature lower than 30° C. below the freezing point by freeze vacuum drying. This resin composition is hard to cause agglutination of anisotropic particles having large aspect ratios.

### BACKGROUND OF THE INVENTION

1. Field of the Invention

The present invention relates to a resin composition comprising a thermoplastic resin blended with inorganic particles having a specific major axis and a specific aspect ratio which is available for an optical film o sheet and has distinguished transparency and mechanical strength, and a method for manufacturing the resin composition.

2. Description of Related Art

Typically, a thermoplastic resin blended with anisotropic inorganic particles having large aspect ratios create properties of a thermoplastic resin such as mechanical strength and heat resistance when blended in a thermoplastic resin. A thermoplastic resin blended with, for example, glass fibers takes on notably enhanced heat resistance and high mechanical strength. However, in this case, since tens of percents of glass fibers are blended in, the glass fiber-bearing thermoplastic resin looses its own transparency, whereas it is often colored or tinged for use as automotive parts. At the same time, saving of energy is strongly demanded mostly to automotive parts against the background of growing environmental concerns in recent years. In particular, alternative materials having comparable heat resistance and high mechanical strength are called for on glass fiber-bearing resins for improvement of fuel economy by vehicle weight saving and waste prevention.

There has been proposed in, for example, Unexamined Japanese Patent Publication No. 51-109998, an approach for the realization of distinguished heat resistance and mechanical strength by a thermoplastic resin bearing just a few percents of a microdispered swelling layer silicate. The swelling layer silicate has an interlayer space between layer surfaces which are smooth on the atom level and chemically stable. Since the layer surfaces forming an interlayer space are chemically stable and is electronegative, it is possible to interbed different organic compounds having ionicity or strong polarity. Such an organic compound is capable of dispersing in hydrophbe such as a thermoplastic resin due to physical bonding through weak ionic bonds or weak hydrogen bonds to the layer surface of the swelling layer silicate. The thermoplastic resin has the potential to obtain desired transparency when fine particles of the layer silicate modified by an inorganic compound are small in size and are microscopically dispersed.

However, because of the fact that a lateral face of fine particles of the of the layer silicate modified by an inorganic compound has bare hydrate hydroxyl groups, it is hard for the base substance to have distinguished transparency due to an occurrence of secondary agglutination through hydrogen bonds of these hydroxyl groups and unattained microdispersion of the fine particles on account of bad compatibility with the base substance. General approach for the problem is to control the secondary agglutination of the fine particles by blocking their hydrogen bonds through silane finishing for lateral hydroxyl groups. This approach is, however, not satisfactory enough to inhibit secondary agglutination completely Japanese Patent No. 2636204 describes a process for preventing an occurrence of secondary agglutination. The process includes the steps of suspending layer silicate in water for swelling, freeze-drying the suspension to fix a dispersal state of the layer silicate, and treating the microdispersed layer silicate with plasma to cause them to react with an organic compound from layer surfaces to interlayer surfaces. However, in the case where a layer silicate with surfaces untreated with an organic compound is suspended in water, this process makes it hard to maintain a dispersal state where interlayer separation is fully achieved even performing the freeze-dry of the suspension. Consequentially, there is still a strong demand for a thermoplastic resin, available for an optical film or sheet, that is provided with distinguished transparency and high mechanical strength through agglutination inhibition of anisotropic inorganic particles having large aspects such as a swelling layer silicate in the base substance.

### SAMMARY OF THE INVENTION

It is an object of the present invention to provide a resin composition comprising a thermoplastic resin and inorganic particles which is prevented from causing agglutination of the inorganic particles, if anisotropic type having a large aspect ratio, so as thereby to have distinguished transparency and mechanical strength sufficiently enough to be used for optical films or optical sheets.

It is another object of the present invention to provide a method for manufacturing a resin composition which comprises a thermoplastic resin and anisotropic inorganic particles which is inhibited from causing agglutination of the anisotropic inorganic having large aspect ratios and has distinguished transparency and mechanical strength sufficiently enough to be used for optical films or optical sheets.

According to one aspect of the present invention, the foregoing object is accomplished by a resin composition comprising a thermoplastic resin and inorganic particles having major axes less than 1 μm and aspect ratios in a range of from 3 to 1000 and dispersant both of which are frozen and dried at a temperature lower than 30° C. below the freezing point by means of freeze vacuum drying before blended with the thermoplastic resin.

The inorganic particles and the dispersant are blended with the thermoplastic resin preferably in a range of from 0.5 to 30% by mass and frozen and dried preferably within one hour.

According to another aspect of the present invention, the foregoing object is accomplished by a method for manufacturing the resin composition comprises the steps of preparing a dispersion liquid of the inorganic particles and the dispersant dispersed in a solvent, freezing and drying the dispersion liquid at a temperature lower than 30° C. below the freezing point by means of freeze vacuum drying, and blending the inorganic particles and the dispersant with the thermoplastic resin.

The resin composition manufacturing method may further comprise the step of blending the inorganic particles and the dispersant after freeze vacuum drying with the thermostatic resin by means of melt kneading. The freeze vacuum drying is completed preferably within one hour.

The resin composition thus composed and manufactured has distinguished transparency and mechanical strength sufficiently enough to be used for optical films or optical sheets resulting from agglutination inhibition of anisotropic inorganic particles, such as swelling layer silicate, having a large aspect ratio.

### DETAILED DESCRIPTION OF THE PREFERRED EMBODIMENTS

The following detailed description will be directed to a method for manufacturing a resin composition. Though the resin composition is not described with specific embodiments thereof separately but will be intelligible from the description of the resin composition manufacturing method.

A resin composition according to an embodiment of the present invention comprises a thermoplastic resin, and inorganic particles which should have major axes less than 1 μm and aspect ratios in a range of from 3 to 1000 and a dispersant both of which are blended with the thermoplastic resin.

A resin composition manufacturing method comprises the steps of dispersing inorganic particles having major axes less than 1 μm and aspect ratios in a range of from 3 to 1000 in a thermoplastic resin together with a dispersant in a solvent, vacuum freeze drying the dispersion liquid at a temperature lower than 30° C. below the freezing point, and, thereafter, blending the inorganic particles with a thermoplastic resin.

Various thermoplastic resins can be nonrestrictively available for the resin composition and are sorted according to applications of the resin composition. Preferred examples of the thermoplastic resin include, but not limited to, resins having transparency sufficiently enough to be suitable for optical applications such as polyester, polyolefin, polymethacrylic acids, etc. Among them, it is preferred to employ polyethylene terephtharate (PET), polycarbonate (PC) or methyl polymethcrylate in terms of distinguished transparency. It is preferred for the resin composition to contain the thermoplastic resin in a range of from 70 to 99.5% by mass relative to 100% by mass of the resin composition. If the thermoplastic resin content is less than 70% by mass, the inorganic particles becomes hardly dispersible and, in consequence, the thermoplastic resin, and hence the resin composition, possibly encounters deterioration in transparency, besides mold products bearing the resin composition become as brittle as unbearable under practical use in some cases. On the other hand, if the thermoplastic resin content is less than 90% by mass, the thermoplastic, and hence the resin composition, is somewhat hardly improved in mechanical strength.

Various inorganic particles can be nonrestrictively available for the resin composition as long as they have the specific major axis and aspect ratio described above, and are sorted according to applications of the resin composition. Preferred examples of the inorganic particles include, but not limited to, swelling layer silicates, strontium carbonate whiskers, zinc oxide whiskers, carbon nanotubes, etc. In this instance, the term “swelling” as used herein shall mean and refer to the property of swelling due to an interstitial solvent such as water, alcohole, ether, etc.

Examples of the swelling layer silicates include a smectite group of clay minerals, a swelling mica group of mica clay minerals, vermiculite, etc. More specifically, examples of the smectite group of clay minerals, natural or synthetic, include, but not limited to, hectorite, saponite, stibensite, hiderite, montomorillonite, nontrite, bentonite, etc. Commercially available examples of the smectite group of clay minerals, natural or synthetic, include, but not limited to, Raponite XLG, and Raponite RD, both anarogous products of synthetic hectorite, (Laporte Cororation, U.K); Samabis, a product analogous to synthetic hectorite, (Henckel Corporation, DE); Smectone SA-1, a product analogous to saponite, and Kunipia F, natural montomorillonite, (Kunimine Inductries Co., Ltd. PN); Bengel, natural montomorillonite, (marketed by Tojojunn Yoko Co., Ltd. PN); Begum, natural hectorite, (Vanderbilt Co., Ltd. U.S.A); Dymonite, synthetic swellfish mica, (Topy Industries, Limited, JPN); Somasyf, synthetic swellfish mica, and Rusentite SWN and Rusentite SWF, both synthetic smectite, (Co-op Chemical Co., Ltd.); etc. Examples of the swelling mica group of mica clay minerals include, but not limited to, Na-type tetracylicyx fluorine mica, Li-type tetracylicyx fluorine mica, Na-type fluorine teniorite, Na-type fluorine teniorite, etc.

These silicates may be used individually or in any combination of two or more of them.

As previously described, the inorganic particles should have major axes less than 1 μm and aspect ratios in a range of from 3 to 1000. More specifically, the aspect ratio is preferred to be in a range of from 3 to 100 for the swellfish layer silicate and in a range of from 5 to 100 for strontium carbonate whiskers in the viewpoint of transparency and dispersibility. If the major axis is less than 1 μm, the thermoplastic resin, and hence the resin composition, possibly encounters deterioration in transparency even when increasing the inorganic particle content. If the aspect ratio is less than 3, the thermoplastic resin, and hence the resin composition, is hardly improved in mechanical strength and, in consequence, it is essential to blend a large amount of the inorganic particles. On the other hand, if the aspect ratio exceeds 1000, the thermoplastic resin, and hence the resin composition, is notably improved in mechanical strength and, however, looses transparency.

Major axes and aspect ratios of the inorganic particles may be worked out in an ordinary way widely known in the art. For example, it is suitable to examine cross sections of sample sheets microscopically at a magnification of from 500 to 20000 using an electronic microscope. The sample sheet is prepared by extrusion molding, hot drawing and cutting a sheet using a microtome.

The dispersant, that is used for surface treatment of the inorganic particles, is not bounded by type and may be sorted according to application of the resin composition. Preferred examples of the dispersant include, but not limited to, compounds containing an organic onium ion, an organic hydroxy compound, an organic silane compound, an organic halogen compounds, an epoxy group-bearing compound, etc. These dispersant may be used individually or in any combination of two or more of them.

Examples of the organic onium ion include an ammonium ion, a phosphonium ion, sulfonium ion, etc. It is preferred to use an ammonium ion or a phosphonium ion, and more preferably a phosphonium ion in terms of heat resistance, among them. The phosphonium ion is expressed by the following constitutional formula.

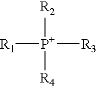

In the constitutional formula R₁, R₂, R₃, and R₄ are groups selected from a group of hydrocarbon groups containing hydrogen, or an alkyl group, a carboxyl group, a hydroxyl group, a phenyl group or an epoxy group which is of a carbon number in a range of from 1 to 20. In this instance, the alkyl group or the phenyl group may have a group selected from a group of halogen, a hydroxyl group, a carboxyl group or —COOR (R is an alkyl group of a carbon number in a range of from 1 to 5) substituted for some hydrogen atoms.

Examples of the organic hydroxyl compound include, but not limited to, a variety of alcohol of carbon numbers in a range of from 1 to 20 such as methyl alcohol, ethyl alcohol, propyl alcohol, butyl alcohol, hexyl alcohol, octyl alcohol, cycohexanol, benzene alcohol, etc. Examples of the organic halogen compound include, but not limited to, a variety of halogen hydrocarbon groups having carbon numbers in a range of from 1 to 20 such as chloride, fluoride, bromide and iodide of methyl, ethyl, propyl, butyl, hexyl, octyl, cyclohexyl or benzene. Examples of the silane compound include, but limited to, those expressed by the following general formula.
RnSiX₄-n
where R is the hydrocarbon group; X is a halogen atom, OR group or OH group; and n is an integer of 1, 2 or 3.

Examples of the compound expressed by the general formula include, but not limited to, trimethyl chlorocilane, diethyl dichlorocilane, phenyl trchlorocilane, methylphenyl dichlorocilane, vinyl trichlorosilane, phenyl cilanol, trimethyl ethoxysilane, phenyl triethoxysilane, etc. Comercially available examples of the compound expressed by the general formula include, but not limited to, n-tetradidecyl triphenyl phosphonium bromide, and Plainact KR-44 and Plainact KR-138S (Ajinomoto Co., Inc., JPN). Etc.

It is preferred to disperse a total amount of the inorganic particles and the dispersant in a range of from 0.5 to 30 by mass relative to 100% by mass of the resin composition. If the total amount is less than 0.5% by mass, the thermoplastic resin, and hence the resin composition, possibly deteriorates mechanical strength. If the total amount exceeds 30% by mass, there occurs possible deterioration in dispersibility of the inorganic particles or transparency of the thermoplastic resin. Consequently, mold products bearing the resin composition become as brittle as unbearable under practical use in some cases.

The solvent is used to dissolve or suspend the inorganic particles together with a dispersant. Various solvents can be nonrestrictively available and appropriately sorted according to surface qualities of anisotropic inorganic particles and applications of the resin composition. Preferred examples of the solvents include, but not limited to, water, acetone, methyl alcohol, ethyl alcohol, isopropyl alcohol, etc. These solvents may be used individually or in any combination of two or more of them.

A blended amount of the inorganic particles is preferably in a range of from 0.1 to 4% by mass. If the blended amount is less than 0.1% by mass, the inorganic particles is hardly dispersed in the solvent and possibly become less lot productive. If the blended amount exceeds 4% by mass, the inorganic particles becomes apt to gel and deteriorate dispersibility in the solvent.

The blended amount of the dispersant is preferably in a range of from 0.05 to 10% by mass. If the blended amount is less than 0.05% by mass, it is hard for the inorganic particles to disperse in the solvent or to cause agglutination much enough to deteriorate transparency of the thermoplastic resin. If the blended amount exceeds 10% by mass, a large amount of nonreacted dispersant are left, This is possibly conductive to deterioration in mechanical strength of the thermoplastic resin. The inorganic particles and the dispersant may be dispersed or suspended in an ordinary way widely known in the art.

The dispersion or suspension liquid should be dried by a freeze vacuum drying method after dispersion or suspension of the inorganic particles together with the dispersant. When the freeze vacuum drying is performed for a dispersion liquid before dispersant is dispersed or suspended, the thermoplastic resin deteriorates transparency and mechanical strength. The freeze vacuum drying is not bounded by form and may be performed in any ordinary way known in the art. In terms of freezing a dispersal state of the inorganic particles in the dispersion liquid, it is preferred to perform vacuum drying keeping a freezing temperature after completion of freeze up. In order to maintain a dispersal state of the inorganic particles, the freeze vacuum drying should be performed at a temperature lower than 30° C. below the freezing point. The freezing and drying temperature is preferably lower than 30° C. below the freezing point in terms of quick freeze up. If the freezing temperature is higher than 30° C. below the freezing point, the dispersed inorganic particles encounter an occurrence of orientation and agglutination. The freezing is not bounded by time and is variable according to applications of the resin composition. At the same time, it is preferred to complete freezing within one hour in terms of prevention of orientation and agglutination. The vacuum is not bounded by intensity as long as sufficiently high enough to remove the solvent to a certain extent and to provide a desired vacuum for drying and, at the same time, preferably in a range of from 3.3 to 26.6 Pa When performing secondary vacuum drying, the drying temperature and vacuum are preferably in a range of from 20 to 50° C. and a range of from 9.9 to 40 P, respectively.

After removal of the solvent through the freeze vacuum drying, the inorganic particles and dispersant are blended with the thermoplastic resin. The blending is not bounded by form and may be performed in any ordinary way known in the art. It is preferred to blend them by melt kneading in terms of a variety of optional ways for the inorganic particles and the like. Further, the melt kneading is not bounded by machine and may be performed by, for example, a single shaft extrusion machine, a unidirectional double shaft extrusion machine, a bi-directional double shaft kneading machine, a continuous kneading machine of a stone mill type which kneads substances between a rotary disk and a stationary disk, a Banbury type mixer, a roll mill, etc. The resin composition obtained by the melt kneading may be further vacuum dried or hot air before the event of extrusion molding or injection molding.

The resin composition may contain other commonly available additives as far as it does not deteriorate transparency and mechanical strength. Examples of the additives include antioxidand, light stabilizer, heat stabilizer, plasticizer, flame retardant, crosslinking agent, antistatic agent, compatibility fortifier (e.g. polyester copolymer comprising monomer having an amid group and/or a sulfonic group for substituents), etc.

The resin composition is molded to sheet products, film products, or solid products or parts using various molding methods. The resin composition is available in the rough for sheet or film products and preferably drawn using a shingle shaft drawing machine or a double shaft drawing machine.

The resin composition thus manufactured is excellent in transparency and mechanical strength, it is suitably used for a wide variety of molding products, optical films, optical sheets, supports for electromagnetic recording mediums, support for image recording mediums, etc.

In order to assess the resin composition, various examples of the resin composition were made of inorganic particles of the following examples I-XII.

### EXAMPLE I

A dispersion liquid of an inorganic layer silicate was prepared by dispersing 2% by mass of Rusentite SWN synthetic smectite (Co-op Chemical Co., Ltd.) for the inorganic particles, 0.2% by mass of hexadecil triphenylphosphonium bromide containing hexadecil triphenylphosphonium ions for the dispersant in 200 ml of solvent I comprising seven parts of water and one part of acetone, and then organized through ion exchange.

The dispersion liquid was frozen at a temperature of 50° C. below the freezing point for 30 minutes to fixed a dispersal state of the inorganic particles using a freeze drying machine, model Triomaster IIA-04 (Kyowa Shinku Co., Ltd.) and, then, dried in a vacuum of 6.6 Pa until the solvent is removed 90%. At this time, the drying was performed with a reduction in pressure such that the dispersion liquid does not produce an increase in temperature beyond a sublimation decay temperature while cooling and observing a sample of the dispersion liquid. Thereafter, the dispersion liquid was secondarily dried intensifying the secondary drying pressure up to 13.3 Pa while adjusting pressure so that the sample attains a temperature of approximately 30° C. The depressurization was halted once and then terminated when the pressure bottoms out to complete the inorganic particles of example I (Ex I) that is treated with the dispersant.

### EXAMPLE II

Inorganic particles treated with the dispersant of example II (Ex II) were prepared in the same manner as example I except that the freeze vacuum drying was performed at a temperature of 30° C. below the freezing point for a freezing time of one hour.

### EXAMPLE III

Inorganic particles treated with the dispersant of example III (Ex III) were prepared in the same manner as example I except that the freeze vacuum drying was performed at a temperature of 70° C. below the freezing point for a freezing time of 12 minutes.

### EXAMPLE IV

Inorganic particles treated with the dispersant of example IV (Ex IV) were prepared in the same manner as example I except that Somasyf synthetic swellfish mica (Co-op Chemical Co., Ltd.) was used as the swelling layer silicate.

### EXAMPLE V

Inorganic particles treated with the dispersant of example V (Ex V) were prepared in the same manner as example I except for water in place of the solvent, strontium carbonate whiskers for inorganic particles, and aminoalkyl dialkoxysilane for dispersant.

### EXAMPLE VI

Inorganic particles treated with the dispersant of example VI (Ex VI) were prepared in the same manner as example I except that the freeze vacuum drying was not introduced but only the secondary drying was performed at a pressure of 13.3 Pa.

### EXAMPLE VII

Inorganic particles treated with the dispersant of example VII (Ex VII) were prepared in the same manner as example I except that the secondary drying was performed at a temperature of 120° C.

### EXAMPLE IIX

Inorganic particles treated with the dispersant of example IIX (Ex IIX) were prepared in the same manner as example IV except that the secondary drying was performed at a temperature of 120° C. under a pressure of 1.0×10⁶ Pa.

### EXAMPLE IX

Inorganic particles treated with the dispersant of example IX (Ex IX) were prepared in the same manner as example I except for aluminum borate for inorganic particles and aminoalkyl dialkoxysilane for dispersant.

### EXAMPLE X

Inorganic particles treated with the dispersant of example X (Ex X) were prepared in the same manner as example I except for calcium carbonate for inorganic particles.

### EXAMPLE XI

Inorganic particles treated with the dispersant of example XI (Ex XI) were prepared in the same manner as example I except that the freeze vacuum drying was performed at a temperature of 10° C. below the freezing point for a freezing time of one hour.

### EXAMPLE XII

Inorganic particles treated with the dispersant of example XII (Ex XII) were prepared in the same manner as example I except that the dispersant was added in the solvent but added in a dried product after the freeze vacuum drying and the secondary drying.

Conditions for Preparation of the inorganic particles of examples I-XII are summarized in the following

TABLE I

| | | | | | Drying condition | | | | |
|---|---|---|---|---|---|---|---|---|---|
| | Particles | | Dispersant | | Freeze vacuum | | | Secondary | |
| | | Amount | | Amount | drying | | | drying | |
| Ex | Type | (mass %) | Type | (mass %) | T° C. | H | Pa | ° C. | Pa |
| I | Synthetic | 2 | Hexadecil | 0.2 | −50 | 0.5 | 6.6 | 30 | 13.3 |
| | smectite | | triphenylphosphonium | | | | | | |
| | | | bromide | | | | | | |
| II | Synthetic | 2 | Hexadecil | 0.2 | −30 | 1 | 6.6 | 30 | 13.3 |
| | smectite | | triphenylphosphonium | | | | | | |
| | | | bromide | | | | | | |
| III | Synthetic | 2 | Hexadecil | 0.2 | −70 | 0.2 | 6.6 | 30 | 13.3 |
| | smectite | | triphenylphosphonium | | | | | | |
| | | | bromide | | | | | | |
| IV | Synthetic | 2 | Hexadecil | 0.2 | −50 | 0.5 | 6.6 | 30 | 13.3 |
| | swelling | | triphenylphosphonium | | | | | | |
| | Mica | | bromide | | | | | | |
| V | Strontium | 2 | Aminoalkyl dialkoxysilane | 0.2 | −50 | 0.5 | 6.6 | 30 | 13.3 |
| | carbonate | | | | | | | | |
| VI | Synthetic | 2 | Hexadecil | 0.2 | | | | 30 | 13.3 |
| | smectite | | triphenylphosphonium | | | | | | |
| | | | bromide | | | | | | |
| VII | Synthetic | 2 | Hexadecil | 0.2 | | | | 120 | 13.3 |
| | smectite | | triphenylphosphonium | | | | | | |
| | | | bromide | | | | | | |
| IIX | Synthetic | 2 | Hexadecil | 0.2 | | | | 120 | 1 × 10⁶ |
| | swelling | | triphenylphosphonium | | | | | | |
| | Mica | | bromide | | | | | | |
| IX | Aluminum | 2 | Aminoalkyl dialkoxysilane | 0.2 | −50 | 0.5 | 6.6 | 30 | 13.3 |
| | borate | | | | | | | | |
| X | Calcium | 2 | Aminoalkyl dialkoxysilane | 0.2 | −50 | 0.5 | 6.6 | 30 | 13.3 |
| | carbonate | | | | | | | | |
| XI | Synthetic | 2 | Hexadecil | 0.2 | −10 | 1 | 13.3 | 30 | 13.3 |
| | smectite | | triphenylphosphonium | | | | | | |
| | | | bromide | | | | | | |
| XII | Synthetic | 2 | Hexadecil | 0.2 | −50 | 0.5 | 6.6 | 30 | 13.3 |
| | smectite | | triphenylphosphonium | | | | | | |
| | | | bromide | | | | | | |

Resin compositions of example 1-10 and comparative examples 1-8 were prepared and sample sheets were made of these resin compositions for property assessment as described below.

### EXAMPLE 1

A resin composition of example 1 (Ex 1) was prepared by melt kneading 5% by mass of the inorganic particles of example 1 and 95% by mass of M-PET (Fuji Photo Film Co., Ltd.) which is hereinafter referred to as PET-1 for the a thermoplastic resin using a double screw extrusion machine, Model TEM-37 (Toshiba Machine Co., Ltd). The kneading was performed under conditions of a screw speed of 500 rpm and a temperature of 275° C. Then, a sample sheet of 150 μm in thickness was made from the resin composition Ex 1 using a double extrusion machine at a temperature of 150° C.

### EXAMPLE 2

A sample resin composition of example 2 (Ex 2) and a sample sheet were prepared in the same manner as example 1 except that a thermoplastic resin, NEH270 (Unitika Co., Ltd.) which is hereinafter referred to as PET-2, was used in place of Fuji M-PET.

### EXAMPLE 3

A sample resin composition of example 3 (Ex 3) and a sample sheet were prepared in the same manner as example 1 except that a thermoplastic resin, Easter9921 (Eastman Chemical Co., Ltd.) which is hereinafter referred to as PET-3, was used in place of PET-1. The PET-3 has a melt viscosity of 0.82 dl/g.

### EXAMPLE 4

A sample resin composition of example 4 (Ex 4) and a sample sheet were prepared in the same manner as example 1 except for a thermoplastic resin, PETG6763 (Eastman Chemical Co., Ltd. which is hereinafter referred to as PET-4, used in place of PET-1. The PET-4 has a melt viscosity of 0.82 dl/g.

### EXAMPLE 5

A sample resin composition of example 5 (Ex 5) and a sample sheet were prepared in the same manner as example 1 except for the inorganic particles of example II used in place of the inorganic particles of example I.

### EXAMPLE 6

A sample resin composition of example 6 (Ex 6) and a sample sheet were prepared in the same manner as example 1 except for the inorganic particles of example III used in place of the inorganic particles of example I.

### EXAMPLE 7

A sample resin composition of example 7 (Ex 7) and a sample sheet were prepared in the same manner as example 1 except for the inorganic particles of example VI used in place of the inorganic particles of example I.

### EXAMPLE 8

A sample resin composition of example 8 (Ex 8) and a sample sheet were prepared in the same manner as example 1 except for 1% by mass of the inorganic particle of example V and 99% by mass of polycarbonate, Tafron (Mitsubishi Engineering Chemicals Co., Ltd.) in place of the inorganic particles of example I and PET 1, respectively.

### EXAMPLE 9

A sample resin composition of example 9 (Ex 9) and a sample sheet were prepared in the same manner as example 1 except that the resin composition was made from a transparent thermoplastic resin by adding an ethylene glycol solution of the inorganic particles of example 1 in polyethylene during polymerization.

### EXAMPLE 10

A sample resin composition of example 10 (Ex 10) and a sample sheet were prepared in the same manner as example 1 except for 0.3% by mass of inorganic particles of example 5 and 99.7% by mass of PET 1 in place of 5% by mass of inorganic particles of example I and 99.5% by mass of PET 1, respectively.

### COMPARATIVE EXAMPLE 1-8

Resin composition of comparative examples 1-8 (Exc 1-Exc 8) and sample sheets were prepared in the same manner as example 1 except for the inorganic particles of examples 6-12 in place of the inorganic particles of example I, respectively.

The sample sheets of examples 1-10 and comparative examples 1-8 were assessed on their properties including major axis (MAX), aspect ratio (APR), dispersal state (DPS), tensile elastic modulus (TEM), average molecular weight (AMW) and transparency (TRP1, TRP2). The result of assessment is shown together with comprehensive grade in Table II.

In order to work out major axes (MAX) and aspect ratio (APR) of the inorganic particles, the sample sheet was heated and drawn and cut off using a microtome for creating a cross-section well suited for microscopic observation. The observation of cross-section was performed at magnifications of 500 and 20000 using an electronic microscope.

The dispersal state of inorganic particles was observed using a transmission electron microscope parent and assessed in the following classes.

Assessment Classes for Dispersant State (DPS)

A: Very excellent (no agglomerated particles)
B: Excellent (not more than five agglomerated particles)
C: Moderate (not more than 30% of agglomerated particles)
D Poor (more than 30% of agglomerated particles)

The tensile elastic modulus (TEM) was measured through a tensile test on a sample sheet 10 mm width and 150 mμ thick using a universal tension tester, model STROGRAPH VE 50 (Toyo Seiki Seisakusho, Ltd.). The tensile elastic modulus of the sample sheet was compared with a tensile elastic modulus of a comparative polyethylene terephthalate sheet (containing no inorganic particles and other additives) that was worked out in the same manner and assessed based on how greater in tensile elastic modulus the sample sheet is relatively to the comparative sheet in the following classes.

Assessment Classes for Tensile Elastic Modulus (TEM)

A: Very excellent (more than 50% improved relatively to the comparative sheet)
B: Excellent (more than 20 and not more than 50% improved relatively to the comparative sheet)
C: Moderate (more than 5 and not more than 20% improved relatively to the comparative sheet)
D: Poor (less than 5% improved or aggravated relatively to the comparative sheet)

The average molecular weight (AMW) was worked out from a molecular weight distribution of a resin constituent after removal of the inorganic particles of the sample sheet using a gel-permiation chromatographic tester, model HLC-8220GPC (Shimadzu Corporation). The average molecular weight of the sample sheet was compared with an average molecular weight of the comparative polyethylene terephthalate sheet as described above that was worked out in the same manner and assessed based on how greater in average molecular weight the sample sheet is relatively to the comparative sheet in the following classes.

Assessment Classes for Average Molecular Weight (AMW)

A: Very excellent (more than 50% relatively to the comparative sheet)
B: Excellent (more than 20 and not more than 50% greater proved relatively to the comparative sheet)
C: Moderate (more than 5 and not more than 20% improved relatively to the comparative sheet)
D: Poor (not more than 5% improved or aggravated relatively to the comparative sheet)

The transparency assessment was introduced in different ways as described below.

Overall light transmissivity of the sample sheet was measured in a medium of tritolyl phosphate and was compared with allover light transmissivity the comparative polyethylene terephthalate sheet as described above that was worked out in the same manner. An assessment of first transparency (TPC1) was made based on how greater in transmissivity the sample sheet is relatively to the comparative sheet in the following classes.

Assessment Classes for Transparency (TPC1)

A: Very excellent (more than 90% relatively to the comparative sheet)
B: Excellent (more than 80 and not more than 90% greater proved relatively to the comparative sheet)
C: Moderate (more than 70 and not more than 80% improved relatively to the comparative sheet)
D Poor (not more than 70% improved or aggravated relatively to the comparative sheet)

Further, overall light transmissivity of the sample sheet before and after drawn 1.5 times in length and breadth with heat was measured in a medium of tritolyl phosphate and was compared with allover light transmisivity of the comparative polyethylene terephthalate sheet as described above that was worked out in the same manner. An assessment of transparency (TPC2) of the drawn sheet was made based on how greater in transmissivity the sample is relatively to the comparative sheet in the following classes.

Assessment Classes for Transmissivity (TPC2)

A: Very excellent (more than 90% relatively to the non-drawn sheet)
B: Excellent (more than 80 and not more than 90% greater proved relatively to the non-drawn sheet)
C: Moderate (more than 70 and not more than 80% improved relatively to the non-drawn sheet)
D: Poor (not more than 70% improved or aggravated relatively to the non-drawn sheet)

The sample sheets were comprehensively assessed according to numbers of A lass and B class in the above assessment in the following grades.

Comprehensive Assessment Grade

Good: A class: all; or B class: 1, A class: the rest
Average: B class: less than 3, A class: the rest

No good: Other than the above

TABLE II

| | Thermoplastic | | | | | | | | | | | |
|---|---|---|---|---|---|---|---|---|---|---|---|---|
| | resin | | Inorganic particles | | | | | | | | | |
| | | Content | | Content | MAX | | | | | | | |
| | Type | (%) | Type | (%) | (μm) | APR | DPS | TEM | AMW | TRP1 | TRP2 | Grade |
| Ex 1 | PET1 | 95 | Ex I | 5 | 0.1 | 10 | A | A | A | A | A | Good |
| Ex 2 | PET2 | 95 | Ex I | 5 | 0.1 | 10 | A | A | A | A | A | Good |
| Ex 3 | PET3 | 95 | Ex I | 5 | 0.1 | 10 | A | A | A | A | A | Good |
| Ex 4 | PET4 | 95 | Ex I | 5 | 0.1 | 10 | A | A | A | A | A | Good |
| Ex 5 | PET1 | 95 | Ex II | 5 | 0.1 | 10 | A | A | A | A | B | Good |
| Ex 6 | PET1 | 95 | Ex III | 5 | 0.1 | 10 | A | A | A | A | A | Good |
| Ex 7 | PET1 | 95 | Ex IV | 5 | 0.2 | 20 | A | A | A | A | B | Good |
| Ex 8 | PC | 99 | Ex V | | 0.4 | 20 | A | A | A | A | B | Good |
| Ex 9 | PET1 | 95 | Ex I | 5 | 0.4 | 8 | A | B | B | A | B | Av |
| Ex 10 | PET1 | 99.7 | Ex V | 0.3 | 0.1 | 10 | A | B | A | A | A | Good |
| Exc 1 | PET1 | 95 | Ex VI | 5 | 0.3 | 6 | B | B | A | B | C | NG |
| Exc 2 | PET2 | 95 | Ex VII | 5 | 0.3 | 3 | C | B | A | C | D | NG |
| Exc 3 | PET1 | 95 | Ex IIX | 5 | 0.3 | 10 | C | B | A | B | C | NG |
| Exc 4 | PET1 | 95 | Ex IX | 5 | 1.5 | 20 | D | A | A | D | D | NG |
| Exc 5 | PET1 | 95 | Ex X | 5 | 0.5 | 15 | B | C | A | A | B | NG |
| Exc 6 | PET1 | 95 | Ex XI | 5 | 0.7 | 3 | B | A | A | D | D | NG |
| Exc 7 | PET1 | 95 | Ex XII | 5 | 0.8 | 16 | D | C | A | C | C | NG |
| Exc 8 | PET1 | 95 | Ex XII | 4.5 | 0.7 | 18 | C | B | A | B | C | NG |

It is proved from Table II that the resin compositions of examples 1-10 that contain inorganic particles having major axes less than 1 μm and aspect ratios between 5 and 1000 and dispersant in a thermoplastic resin and are frozen and dried at temperature lower than 30° C. below the freezing point are superior in transparency and mechanical strength to the comparative resin compositions of examples 1-8. In particular, the resin compositions of examples 1-8 that have total contents of inorganic particles and dispersant between 0.5 and 30% by mass take on significant improvement in tensile elastic modulus.

While the exemplary embodiments described above are presently preferred, it should be understood that the embodiments are offered by way of example only. Accordingly, the present invention is not limited to a particular embodiment, but extends to various modifications that nevertheless fall within the scope of the appended claims.

What is claimed is:

1. A resin composition comprising a thermoplastic resin and inorganic particles having major axes less than 1 μm and aspect ratios in a range of from 3 to 1000 and dispersant both of which are frozen and dried at a temperature lower than 30° C. below the freezing point by means of freeze vacuum drying before blended with said thermoplastic resin.

2. The resin composition as defined in claim 1, wherein a total content of said inorganic particles and said dispersant is in a range of from 0.5 to 30% by mass.

3. The resin composition as defined in claim 1, wherein said inorganic particles and said dispersant are frozen and dried within one hour.

4. A method for manufacturing resin composition which comprises a thermoplastic resin and inorganic particles having major axes less than 1 μm and aspect ratios in a range of from 3 to 1000 and dispersant blended with said thermoplastic resin, said resin composition manufacturing method comprises the steps of:
preparing a dispersion liquid of said inorganic particles and said dispersant dispersed in a solvent;
freezing and drying said dispersion liquid at a temperature lower than 30° C. below the freezing point by means of freeze vacuum drying; and
blending said inorganic particles and said dispersant with said thermoplastic resin.

5. The resin composition manufacturing method as defined in claim 4, and further comprising the step of blending said inorganic particles and said dispersant after freeze vacuum drying with said thermostatic resin by means of melt kneading.

6. The resin composition manufacturing method as defined in claim 4, wherein said freeze vacuum drying is completed within one hour.
